(19) United States
(12) Patent Application Publication
(10) Pub. No.: US 2015/0028579 A1
(43) Pub. Date: Jan. 29, 2015

(54) METHOD OF UNITARY AUTHENTICATION OF A HARDWARE OBJECT COMPRISING VISUAL CRYPTOGRAPHY AND MATERIAL SIGNATURE

(71) Applicants: Yann BOUTANT, Chindrieux (FR); Thierry FOURNEL, Saint-Galmier (FR)

(72) Inventors: Yann BOUTANT, Chindrieux (FR); Thierry FOURNEL, Saint-Galmier (FR)

(21) Appl. No.: 14/306,124

(22) Filed: Jun. 16, 2014

Related U.S. Application Data
(63) Continuation of application No. 14/114,265.

(30) Foreign Application Priority Data
May 1, 2011 (FR) 1153713
May 19, 2011 (FR) 1101548

(51) Int. Cl. B42D 25/30; B42D 25/48

(52) U.S. Cl. CPC B42D 25/30; B42D 25/48
USPC 283/67; 358/1.14

(57) ABSTRACT

The invention concerns a unitary authentication process of a material object consisting of a construction phase of an authenticator system comprising at least:
a message image selection step;
a support image selection step;
a message and support images transformation step to generate at least two shared images according to a transformation process implementing at least a random sequence, the message image not being accessible in each shared image taken individually;
a recording step of at least one shared image.
   According to the invention, in the construction phase of an authenticator each random sequence, the so-called material signature, is extracted or generated from at least one structural characteristic of at least one region of the material object and is liable to be generated on request and obtained identically from the material object.

The invention concerns the technical field of transmission of information in a form to allow ensuring, on the one hand, its confidentiality during the transmission and, on the other hand, the transmitter's authentication. In a preferred but not exclusive application, the invention concerns the field of authentication of products, documents and diverse objects, notably to allow a user or an addressee to verify their origin and/or authenticity by notably a visual check.

In the product authentication field, a WO2005/091 232 request proposed to use a known message of the addressee alone and an image of the product and then generate from this message and the background image according to a visual cryptographic process such as described by the U.S. Pat. No. 5,488,664 two images, with one being printed on a label associated with the product and the other communicated to the product's addressee. After receiving the product with its associated label, the user can by overlaying the image communicated to him with the printed image read the message only known to him, which guarantees to him the product's authenticity; if he cannot see the message, he can deduct that infringement has taken place.

Such a system allows guaranteeing the addressee that the product he has received is indeed intended for him and that it was made or addressed by an authorised entity in possession of his secret message. However, this system requires that each label be personalised according to the product's addressee and therefore is not adapted to mass production since this happens well before the product is sold or ordered by an end user.

An international WO2004/063 993 request also proposed to implement a message encrypted according to visual cryptographic techniques and incorporated in a background image to authenticate a commercial instrument such as a transport or show ticket purchased on an online sale service and locally printed out by the purchaser. The international WO 2004/063 993 request proposes like the WO2005/091 232 request to implement a second image, which allows by overlaying with the background image incorporating the encrypted message to reveal the encrypted message in order to ensure the authenticity of the constituent information of the ticket. Such a process allows effectively authenticating the information associated with a ticket within a transaction partially dematerialised, but does not allow authenticating a product which would be associated with this ticket.

The processes known today prove thus to be adapted to the authentication of processes partially dematerialised or even objects whose addressee is known. On the other hand, the known processes appear unsuitable for a strong authentication of material objects whose origin must be capable of being ensured and guaranteed for the end user starting from the insertion in a distribution or routing circuit regardless of the distribution or routing chain and this well before the addressee or the end user is known.

Therefore, it seemed necessary to have a system which is able to allow an authentication of a material object so that its addressee can be sure that the object itself and not simply the authentication device is authentic and/or that the information associated with the object is authentic. It also seemed necessary to have an authentication system which can be implemented without the object's producer or sender having to know the end addressee and/or having to personalise the object according to the addressee or the end user.

In order to attain this goal, the invention concerns a material object authentication process consisting of a construction phase of an authenticator system comprising at least:
a message image selection step;
a support image selection step;
a message and support images transformation step to generate at least two images shared according to a transformation process implementing at least a random sequence, the message image not being accessible in each shared image taken individually;
a recording step of at least one shared image.
   According to the invention, the unitary authentication process is characterised by the fact that in the construction phase of an authenticator each random sequence, the so-called material signature, is extracted or generated from at least one structural characteristic of at least one region of the material object and is liable to be generated or extracted on request and obtained identically or quasi-identically from the material object.

The invention allows creating a one-to-one mapping between the message image and the material object by implementing the material signature for the construction of the shared images.

In the sense of the invention, a random sequence is understood to be a sequence of numbers which are the independent realization of a uniformly distributed variable, that is, equiprobable. Among the random sequences usable within the scope of the invention, binary random sequences composed of a series of binary values independent from one another may be mentioned. A random sequence generated by means of a structural characteristic of an element or material object as described in FR 2 870 376 or FR 2 895 543 corresponds to the definition of a random sequence in the sense of the invention.

In the sense of the invention, the fact that the random sequence used, the so-called material signature, can be generated on request and identically or quasi-identically from the material object corresponds to the fact that this material signature is stable and yet random. A stable random signature extracted from a structural characteristic of a material element as described by FR 2 895 543 is a material signature in the sense of the invention, which can be recalculated or regenerated by a new implementation of the algorithm used on the same region of the element or material object. During the construction of the authenticator system and whenever it is necessary, the material signature is generated or extracted by reading the material element via a material signature extraction device. Due to the random nature of the material signature, each material signature has a different value from one material element to another or from one family of material elements to another, and each signature value cannot be predicted even in the presence of the element or material object except if, of course, the implemented algorithm is known, and, in the case of the algorithm described by FR 2 895 543, the decomposition base used and/or the extraction parameters of the material signature, such as the acquisition window shape and/or the direction in which it is read, are known. In the latter case, the decomposition base and/or the extraction parameters can each be considered as a secret key to extract the material signature.

At each extraction the material signature is identical or quasi identical to that used during the construction of the authenticator system. Quasi identical means that there exists a small variation or difference between the material signatures extracted from the same region of the same material object.

Likewise in the sense of the invention, the structural characteristic can be a proper characteristic of the material object as an individual or in the case of an object obtained from an industrial process aimed at producing a family of material objects having common structural characteristics, the structural characteristic can be a structural characteristic of the family. Among these industrial processes, it is possible to cite processes intended to mould or stamp raw materials in order to obtain shaped parts or parts with a relief. It is also possible to cite industrial processes which consist of assembling various parts in order to obtain manufactured objects or functional assemblies having an identical appearance.

Furthermore, in the sense of the invention, the term recording is understood to mean:
a recording in a printed or analog form;
a recording in an analog form, such as in a form printed in continuous tones;
a recording in a non-electric or non-magnetic digital form, such as in a form printed in half-tones;
a recording in a digital, electronic or magnetic form with computer storage means; without this list being limited or exhaustive.

Recording by printing may require depositing inks or substances which allow obtaining optical properties of the printing support adapted to the realization of shared images.

The process according to the invention is qualified as a unitary authentication process because it ensures the combination of an authentication and an identification.

Authentication can be defined to be the act of establishing that an object is authentic, that is, that it can be considered as having a known and reliable origin. The result of an authentication is a binary response: positive or negative.

Identification is the possibility of recognising or individualising either an object among a family of objects in circulation, or a family of objects among a set of families in circulation. The simplest way to proceed with an identification is to associate or assign a given number called an index to an object or a family of objects. Such an index allows knowing the rank of the object within the family of objects or the rank of the family within the set of families. Identification is not as such a measure of security nor a measure aimed at guaranteeing a security, which is the case of authentication.

In the case of a unitary authentication of an object, the implementation of a material signature generated from the structure itself of the object to be authenticated to generate shared images creates a unique link between the object to be authenticated and the shared images used for the authentication of this object.

Similarly, in the case of the unitary authentication of a family of objects, it will be implemented by a material signature generated from the structure itself of an object of the family to be authenticated, this material signature presenting the particularity of being identical or quasi-identical for the set of objects belonging to the same family, but different for the objects belonging to two separate families. The use of this “family” material signature to generate the shared images creates a unique link between the family of objects to be authenticated and the shared images used to authenticate this object family.

Within the scope of the extraction process, such as defined in the FR 2 895 543 request, the individual material signature of an object can be distinguished from the material signature of a family of objects by the identification of the signature's components which will have, on the one hand, identical values for all the objects belonging to the same family while of course having different values for the objects not belonging to the same family and, on the other hand, different values from one object to another in the same family. The material signature of the family possesses the random character specific to the material signatures according to the invention insofar as the value of the material signature cannot be predicted from one family to another and is distinct from one family to another.

The unitary authentication made by means of the process according to the invention presents a perfect security and, in addition, a very great robustness and reliability insofar as it combines visual cryptography, whose perfect security is proven and recognised, with the material signature which in turn possesses a proven random character and can be reliably calculated even after a given alteration, notably an aging of the material object. In this respect, it should be noted that with each new extraction the material signature is identical or quasi-identical to the one used during the construction of the authenticator system. Quasi identical is understood to mean that during a new extraction a low percentage—for example, less than 10% and preferably less than 5%—of the values of the constituent numbers of the random sequence making up the material signature may be different from the values of the constituent numbers of the sequence making up the material signature used during the construction of the authenticator system or the values of the constituent numbers of the sequence making up a material signature previously extracted. Within the scope of the invention the possibility of such a slight variation of the material signature is not an obstacle to the reliability of the authentication process according to the invention insofar as possible variations of the material signature will generate a possible alteration of a small part only of the shared image reconstructed with the quasi-identical material signature. But the result of the control by overlaying the shared images can be interpreted by a user whose human visual system is able to read or recognise the message image and interpret it even if this message image is partially altered. In this respect, it should be noted that the human visual system allows recognising from fragments geometric forms, images or letters, while from the same fragments an artificial vision system is not able to make any recognition. This capability of recognition despite possible alterations offered by the human visual system is also true in the case of slight alterations of one of the shared images. Thus, the combination of the generation of the random sequence necessary for the visual cryptographic algorithm by means of the material signature and the control by means of the human visual system confers on the process according to the invention a great resistance to the variations of the material object and the possible shared image which it conveys.

Furthermore, the fact that the shared images are constructed by means of the material signature generated by implementing a secret key and/or the fact that the message image can possibly contain a secret mark prevents a third party from being able to surreptitiously change a shared image or generate a dummy shared image.

The unitary authentication process according to the invention can be implemented for objects or products making up a functional set which is not intended to be divided so that the process is implemented to ensure the authentication of the set without necessarily allowing an individual authentication of the elements comprising it. However, the invention can also be implemented for objects or products which are intended to be divided in order to be integrated notably in other objects. For instance, it is possible to cite materials in a plate or braid form which are produced continuously or have dimensions very clearly larger than those of the objects or products which will incorporate them. In order to allow an authentication of this type of object according to a form of implementation of the invention, the construction phase of an authenticator system includes a step to decompose the support image into a finite number of areas and the process includes for at least some the areas, a step to transform the message and support images to generate at least two shared images specific to each area according to a transformation process implementing at least one material signature generated from at least one structural characteristic of at least one region of the said area of the material object. Thus, during the cutting up of the authenticated objects, it will be possible to find on a cut part an area to which at least two shared images will have been associated, thereby ensuring an authentication. The size of the areas may be selected to correspond to the largest surface in one piece liable to be found on a product, which integrates a part of the authenticated object by means of the process according to the invention.

According to a form of implementation of the invention, the construction phase of an authenticator system includes a step to record the location of the object's region from which the material signature is generated.

According to a characteristic of the invention, the message image includes at least a part of the material signature or the value of the material signature in an alphanumeric or graphic form.

In the sense of the invention, a record or a representation in alphanumeric form means a record or a representation in a directly intelligible graphic form consisting of alphabetic and/or numeric characters and/or ideograms. For example, in case the material signature is extracted in the form of a binary sequence, the alphanumeric representation of the material signature can be a series of 0 and 1 corresponding to the said binary sequence, a representation in a decimal or other base of the number corresponding to this binary sequence. In case of a partial graphic representation of the material signature's value, only some of the bits of the binary sequence represented by zeros or ones, or else by a number in a decimal or other base corresponding to the bits selected from the material signature may be retained, for example.

According to the invention, the support image can be of any kind. A support image can be selected among the following types of images:
coloured image;
grey-scale image;
binary image, such as an image with two visual components, like two separate colours, or else two components, one having a specular behaviour and the other a diffusing behaviour;
half-tone image;
image resulting from the assembly of two or more images of the above types; without this list being limited or exhaustive.

The support image can be a uniform image which does not contain any information and, for example, a monochromatic image, such as a white image or a black image, or even an average uniform image resulting from a random distribution of pixels of one colour and pixels of another colour. According to the invention, the support image may, on the contrary, not be uniform and may consist of information elements and/or identifiable forms. Such a support image may then allow an indexing or visual identification insofar as the information that it conveys is visible at the level of at least one of the shared images and can be interpreted by the human visual system and/or an artificial optical recognition or reading system.

According to a characteristic of the invention, the support image can include an image of a region of the material object and/or the structure of a region of the material object.

According to another characteristic of the invention, the message image includes an image of a region of the material object and/or the structure of a region of the material object.

In the sense of the invention, the image of the structure of a region of the material object is understood to be a graphic representation after a possible optical or numeric processing of the structure of a region of the material object. This graphic representation can be in real scale or else involve a scale change such as an enlargement or a reduction. The implementation of an enlargement then renders the details of the structure more easily readable, while the implementation of an optical processing can help facilitate the recognition of the characteristic elements of the structure.

According to the invention, the message image can be of any suitable kind, although preferably in a part at least interpretable or recognisable by the human visual system and possibly in a part at least interpretable by an artificial optical recognition or reading system. The image can include, for example, a part integrating a message in a graphic representation according to a human write system and a part integrating a graphic message for an artificial reading system, such as a bar code and/or a data matrix.

According to a preferred implementation form, the message image is a binary image, such as an image with two visual components. The two components can then be, for example, two distinct colours or two components, one having a specular behaviour and the other a diffusing behaviour.

According to the invention, at least one of the shared images can be recorded by any suitable means. According to an implementation form of the invention, the construction phase of an authenticator system includes a step to record at least one of the shared images in numeric form.

According to a characteristic of this form of implementation, the authentication process according to the invention includes a step to record at least one of the shared images in printed form.

According to a variant of this characteristic, the construction phase of an authenticator system includes a step to print at least one of the shared images of the material object.

According to still another characteristic of the invention, the construction phase of an authenticator system includes a step to record in printed form at least one shared image and a step to record in numeric form at least another shared image.

The authentication process according to the invention allows a user or an addressee of the authenticated object to visually check the authenticity by implementing at least two shared images. Thus, according to an implementation form, the authentication process according to the invention includes in addition a verification step by a user, consisting of:
a presentation step of a shared image to be viewed by the user;
and at least another presentation step of another shared image to be viewed by the user;
   the presentation steps being carried out so that the user perceives the shared images as being overlaid to allow a reading of the message image by the user.

According to a characteristic of the invention, the presentation steps are carried out successively in order to implement a retinal persistence phenomenon in the user or another visual perception phenomenon.

According to another characteristic of the invention, the presentation steps are carried out simultaneously. When each shared image presents the support image which in addition integrates identifiable forms, the presence of these identifiable forms constitutes an aid for an overlay of the shared images so as to obtain a satisfactory revelation of the message image. The presence of identifiable forms in the support image, which are visible in each shared image, can be used to allow the user to select the support image to be used within the scopes of the implementations of the invention calling for the construction of a shared image in the verification phase.

According to the invention, the presentation steps of the shared images can be carried out by any suitable means.

According to a characteristic of the invention, at least one presentation step is carried out by means of an electronic display or projector.

According to another characteristic of the invention, at least one presentation step is carried out by means of at least one printed shared image. This printing can be performed on an opaque, translucid or transparent support.

According to a characteristic of the invention, the verification phase includes a step to extract the material signature.

According to another characteristic of the invention, the verification phase includes a step to generate a shared image.

According to still another characteristic of the invention and when at least one shared image has been recorded in electronic form, the verification phase includes a step to download a shared image from a remote server.

The process of transforming support and message images into shared images is like an algorithm related to visual cryptography. According to the invention, the transformation process implemented to transform the message and support images into at least two shared images can implement any adapted visual cryptographic algorithm. It is possible, for example, to use the visual cryptographic algorithms implementing a support image described and referenced in the publication “A Comprehensive Study of Visual Cryptography” by Jonathan Weir and WeiQi Yann [Y. Q. Shi (ed): Transactions on DHMS V, LNCS 6010, pp. 70-105, 2010 ©Springer-Verlag Berlin Heidelberg 2010]. In the context of this publication:
the notion of image message, in the sense of the invention, corresponds notably to the “secret”, “secret image” terminology;
the notion of support image, in the sense of the invention, corresponds notably to the “cover image”, “base image” terminology;
and the notion of shared images, in the sense of the invention, corresponds notably to the “share”, “merged share” or even “secure mask” terminology.

The invention also aims at a transformation process transforming a message image and a support image into at least two shared images by means of at least one random sequence, the message image not being accessible in each shared image taken individually and revealed by a real and/or virtual overlay of the shared images. According to the invention, each shared image presents the support image in an altered form and when the shared images are overlaid, an image is obtained containing the message image and the support image in its original form except in the regions at least partially hidden by the message image.

Thus, the invention also aims at a transformation process transforming a binary message image and a support image containing at least one colour plane into n shared images, which share the message image without any loss of information, reflect the support image, and are intended to reveal the message image to be viewed by a user by the presentation of at least k separate shared images, k satisfying the relationship 2≦k≦n.

According to a characteristic of the invention, the transformation process of the support and message images includes the following steps:
choice of a presentation mode of operation of at least k separate shared images to display the support image, k satisfying the relationship 2≦k≦n
choice of a reference binary value among the two possible values for the pixels of the message image;
division of the support image into support cells, each associated with a pixel of the message image;
implementation of two collections of transformation boolean matrices, the first collection being associated with the reference binary value and the second collection being associated with another binary value, with the boolean matrices being such that:
   for any integer q such that 1≦q<k≦n, the two sets formed by the submatrices with q lines and m columns extracted from the boolean matrices in each of the two collections are indistinguable;
   the mode of operation applied to any k-tuplet of lines of any boolean matrix of a collection can reveal a difference with the resultant of the mode of operation applied to any k-tuplet of lines of any boolean matrix of the other collection;
for at least some of the support cells, drawing by means of a random sequence of a transformation boolean matrix in the collection corresponding to the binary value of the message pixel associated with the support cell;
assembling of the selected boolean matrices possibly completed by neutral values for n mask images of the same size as the support image;
for at least one colour plane, construction of n shared images from n mask images and/or the support image.

According to the invention, the construction of the collection pairs of boolean matrices can implement a binary scheme, such as described by the patent U.S. Pat. No. 5,488,664 or else in the publication “Visual Cryptography” by M. Naor and A. Shamir, Advances in Cryptology—Eurocrypt '94 Proceedings, LNCS vol. 950, Springer-Verlag, 1995, pp. 1-12. In the context of this publication:
the notion of message image, in the sense of the invention, corresponds notably to the “message” or “secret message” terminology;
the notion of cell, in the sense of the invention, corresponds notably to the “share” terminology;
and the notion of cell pixel, in the sense of the invention, corresponds to the “subpixel” terminology.

According to a characteristic of the invention, at least one shared image is independent of the message image and each other shared image depends on the message image. This characteristic corresponds to the fact that within the scope of the construction algorithm of shared images described above, at least one shared image results from a mask image independent of the message image and each of the other shared images results from a mask image dependent on the message image. To this end, the collections of boolean matrices are such that for a predetermined index J and any rank i, the line number J of the ith matrix of the first collection C₀ is equal to the Jth line of the ith matrix of the second collection C₁, the two collections having the same number of matrices. (cf FIG. 6)

Within the scope of this characteristic, the shared image resulting from a mask image independent of the message image can be either the said mask image or the result of the application of the mask image to the support image.

According to a characteristic of the invention, the transformation process includes a step to select a polychromatic or non-polychromatic support image.

According to a characteristic of the invention, at least one shared image is independent of the support image and results from a mask image dependent on the message image, and each of the other shared images is obtained by applying a mask image dependent on the image to the support image.

According to another characteristic of the invention, each shared image is obtained by applying a mask image to the support image.

According to a form of implementation of the transformation process according to the invention, each random sequence used comes from a material signature extracted from at least one structural characteristic of a region of a material object.

According to a realization variant of this form of implementation, the message image includes a reference to the message's origin. This reference can be notably a secret mark.

According to another characteristic of the transformation process conforming to the invention, each random sequence is recorded.

According to a characteristic of the invention, the process includes a selection of the support cells for which a transformation boolean matrix is drawn.

According to a variant of this characteristic, the support cells are randomly selected.

According to another variant of this characteristic, the support cells are selected according to the real or virtual curves or lines in the support image.

According to still another variant of this characteristic, the total number of selected support cells corresponds to at least 50% of the number of pixels of the message image to guarantee a possible deciphering of the message by the human visual system.

The transformation process according to the invention can include a step to record at least one of the shared images in numeric form.

The transformation process according to the invention can also include a step to record at least one of the shared images in printed form.

According to a characteristic of the invention, the transformation process according to the invention includes a step to print at least one shared image and a step to record at least another shared image in numeric form.

According to a characteristic of the invention, the support image contains at least two colour planes. A colour plane should be understood to be the decomposition according to one of the constituent components of the support image. In the case of a coloured image, there are at least three colour planes, one for each of the primary colours; in the case of a monochromatic image, there is one colour plane. A colour plane may be binary or, on the contrary, correspond to an encoding of an intensity level on several bits for each pixel. In the case of a black & white image, there is only one colour plane.

Of course, the various characteristics, variants and forms of implementation and realization of the authentication process and the transformation process conforming to the invention can be associated with one another according to various combinations insofar as they are not incompatible with one another or mutually exclusive.

Furthermore, various other characteristics of the invention are focused on in the auxiliary description made by referring to the drawings which show the unlimited forms of implementation of the processes conforming to the invention.

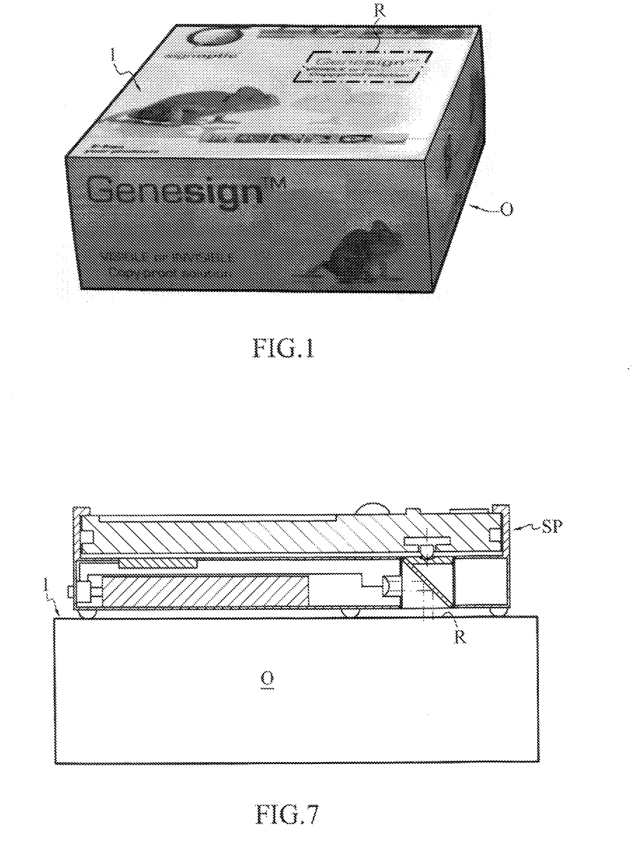

FIG. 1 is a perspective view of a product liable to be authenticated by means of the process according to the invention.

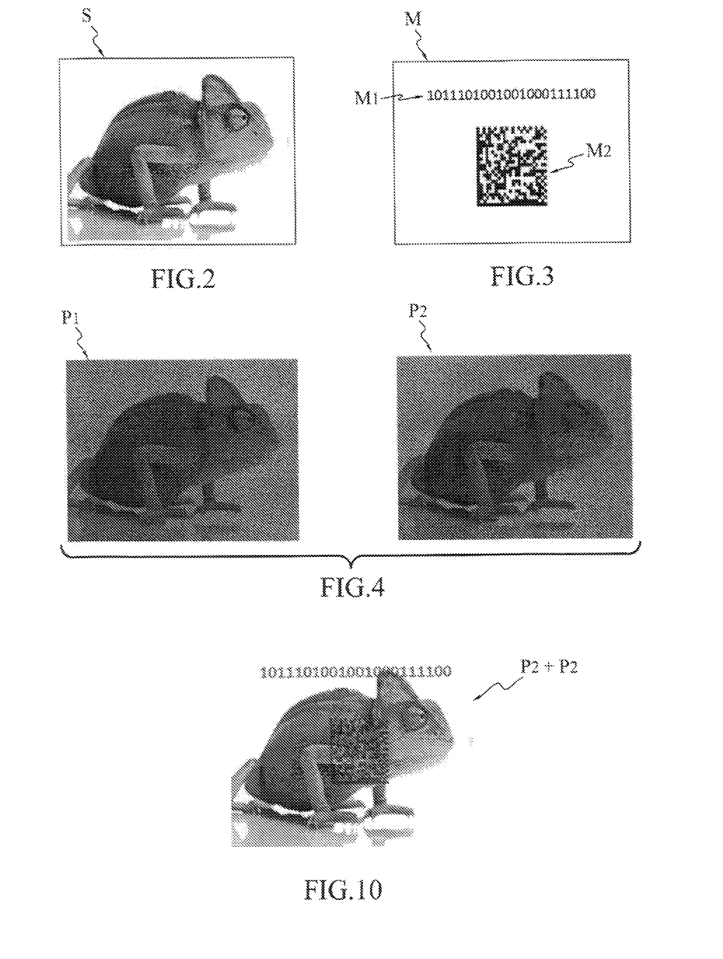

FIG. 2 is a support image which corresponds to a part of the image of the upper surface of the product shown in FIG. 1 and which is used within the scope of the process according to the invention.

FIG. 3 is a message image which is used within the scope of the process.

FIG. 4 shows two shared images which form a visual authenticator system and which are constructed by implementing the process according to the invention with the support and message images shown respectively in FIG. 3 and FIG. 4.

FIG. 5 shows an example of two collections of boolean matrices implemented to construct the shared images.

FIG. 6 shows another notation of the two collections of boolean matrices of FIG. 5.

FIG. 7 shows a device to extract a material signature, such as describe in the FR 2 907 923 request placed on the upper surface of the product shown in FIG. 1.

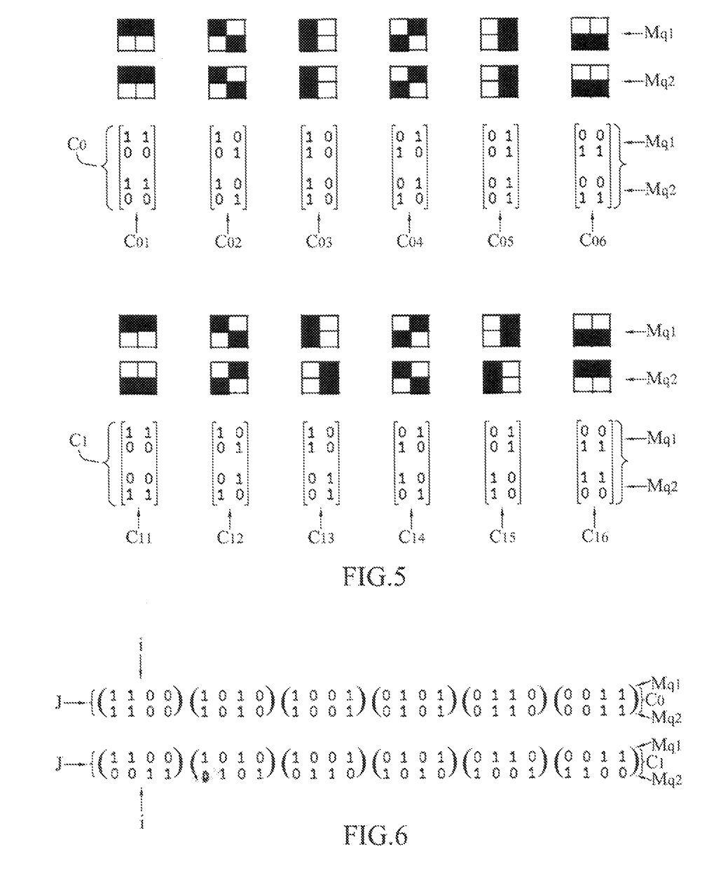

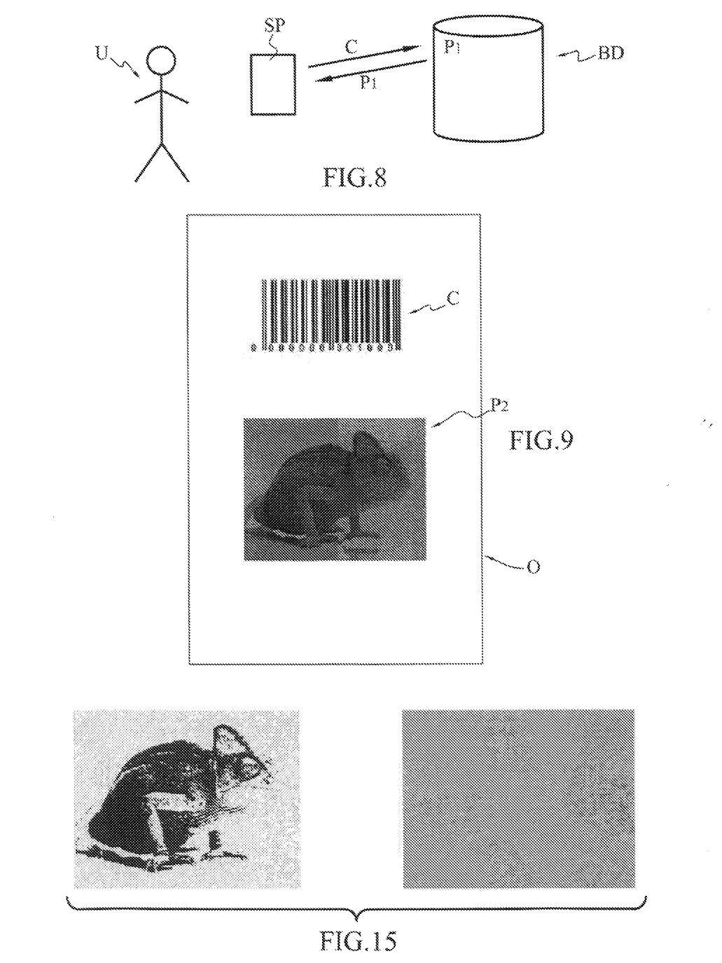

FIG. 8 shows an implementation scheme of the invention with a recording of the first shared image in a remotely accessible database.

FIG. 9 is the result of the overlay of the shared images of FIG. 4.

FIG. 10 shows the rear surface of the product represented in FIG. 1; one of the two shared images represented in FIG. 4 is recorded by printing on this rear surface.

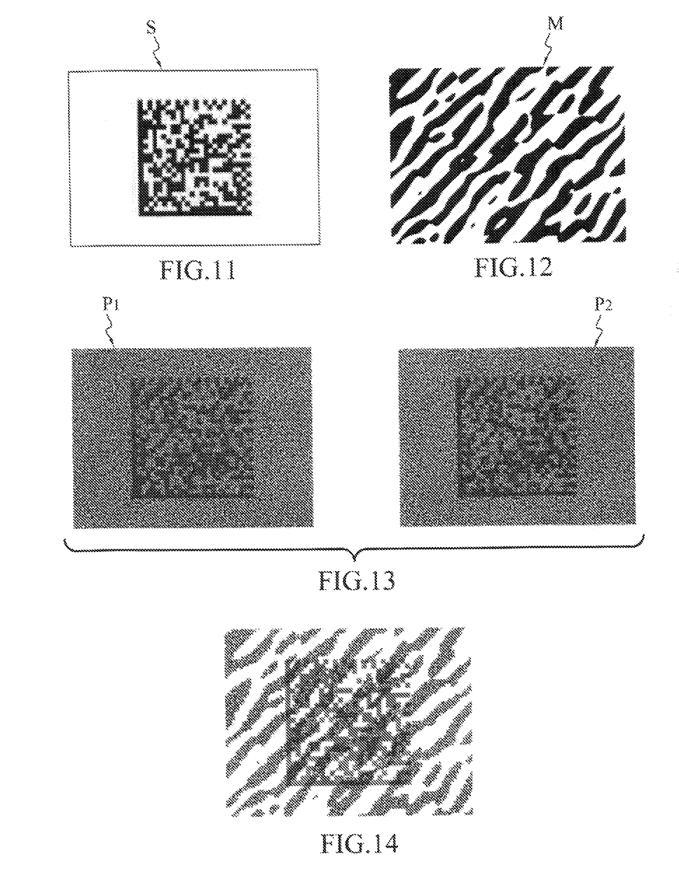

FIG. 11 is another support image used within the scope of the process according to the invention.

FIG. 12 is another message image used within the scope of the process.

FIG. 13 shows two shared images which make up a visual authenticator system and which are constructed by implementing the process according to the invention with the support and message images shown respectively in FIG. 11 and FIG. 12.

FIG. 14 is the result of the overlay of the shared images of FIG. 13.

FIG. 15 shows two shared images which make up an authenticator system and which are constructed by implementing the process according to the invention with the support and message images shown respectively in FIG. 3 and FIG. 4 and for which only one shared image, that to the left, reflects the support image, while the right shared image does not reflect any information. The overlaying of the shared images of FIG. 15 allows obtaining the result shown in FIG. 5.

The invention proposes to implement an authenticator system which allows a user to visually proceed with an authentication associated with an identification of a material object in his possession. Such an object O can be, for example, a packing box or a packing case such as shown in FIG. 1. Of course it is only an example here since the invention can be applied to any type of material object, provided this object includes material in the solid state for which the evolution and/or spontaneous degradation process is very clearly longer than the delay between the construction phase of the authenticator system and the verification phase. It is understood by “very clearly longer” that the delay from which the first evolutions or spontaneous degradations will take place is at least twice as long and preferably longer than two orders of magnitude in delay between the construction phase of the authenticator system and the verification phase. An image according to a given viewpoint of a natural scene, such as a landscape, a street, a monument, a building or other, can constitute a material object which can be authenticated by the invention and can be used as the basis for an extraction of a material signature liable to be extracted identically or quasi identically from another image of the same natural scene according to the same or quasi same viewpoint.

Among the material objects liable to be covered by a unitary authentication by implementing the invention, the following can be mentioned:
industrial or manufactured products as such, regardless of their material and/or their components, notably for brand protection type applications;
the packaging and/or outer packaging of these products;
the official documents, such as identity documents, fiduciary documents, currencies, or other;
the access documents to a site, a machine or a department;
any document requiring an authentication;
without this list being limited or exhaustive.

In order to construct a system of visual authenticators, the invention proposes to implement a support image S, FIG. 2, and a message image M, FIG. 3, which are transformed by means of a visual cryptographic algorithm into at least two and, according to the illustrated example, exactly two shared images P1 and P2, FIG. 4. One of the essential characteristics of the invention resides in the fact that the incidental, called within the scope of the invention random sequence, necessary for the implementation of the visual cryptographic algorithm is supplied by the material signature extracted from at least one structural characteristic of at least one region of the material object O.

According to the illustrated example, the support image S corresponds to the image of a part of the upper surface 1 of the object O, it being understood that any other image may be used as the support image.

Still, according to the illustrated example, the message image M includes a message M1 which is liable to be interpreted by the human visual system and which, in the present case, corresponds to a binary sequence of zeros and ones. The message image M also includes a message M2, which is liable to be interpreted by an artificial optical recognition or reading system and which, in the present case, corresponds to a data matrix. According to the invention, the message image may include only one message M1, which is intelligible to the human visual system, or one message M2, which is intelligible to an artificial optical recognition or reading system. The message image can also include a message which is intelligible both to the human visual system and to an artificial optical recognition and reading system.

The system of visual authenticators can be constructed in the following way for a system of authenticators with two shared images intended to be overlaid for the reading of the message M.

The message image M contains a given number of message pixels: for the illustrated example, 18720 pixels for an image of 5 cm by 6.5 cm (156 pixels×120 pixels).

The support image is divided into cells and each cell is associated with a pixel of the message image so that there are as many support cells as message pixels. Each of the support cells contains a given number of adjacent pixels preferably greater than or equal to two and according to the illustrated example equal to four. It should be noted that the support image resolution is selected so that for a surface equal to that of the message image the support image has a sufficient number of pixels to be divided into as many support cells as the existing image pixels. Thus, for the illustrated example in which each support cell contains four pixels, the support image S will have 74 880 pixels, that is, a resolution of 312 pixels×120 pixels for a surface of 5 cm by 6.5 cm.

Prior to the construction of the shared images as such, mask images should be constructed equal in number to the shared images, here two.

Two collections C₀, C₁ of boolean matrices are implemented, for which an example is illustrated in FIG. 5, within the scope of the implementation of the square support cells of four pixels. Each collection corresponds to one of the two possible values for each pixel of the message image M. The first collection C₀ of matrices can, for example, correspond to the value 0, while the second collection C₁ can correspond to the value 1. Each collection contains a number of subcollections and each subcollection contains as many matrices as the number of shared images.

In FIG. 5, the subcollections correspond to the columns of each collection C₀, C₁. In the present case, each collection contains six subcollections, respectively, C₀₁ to C₀₆ and C₁₁ to C₁₆. Each subcollection contains, according to the illustrated example, two matrices corresponding to two support cells, one supporting the first mask image Mq₁ and the other the second mask image Mq₂. To facilitate the representation, in FIG. 5, in each collection, the first line corresponds to the possible values of the cells of the first mask image, while the second line corresponds to the possible values of the cells of the second mask image.

In addition, the mask cells corresponding to the matrices of the subcollections are represented above the collections. In a preferred form of implementation, the two collections contain the same number of subcollections; however, this is not necessary for the implementation of the invention.

For each message pixel, the following process takes place:
If the message pixel value is 0, the first collection C₀ is implemented. Then a subcollection is randomly selected from among the subcollections C₀₁, C₀₂, C₀₃, C₀₄, C₀₅, C₀₆.
If the message pixel value is 1, the second collection C₁ is implemented. Then a subcollection is randomly selected from among the subcollections C₁₁, C₁₂, C₁₃, C₁₃, C₁₄, C₁₅, C₁₆.

The matrix at the top of the selected subcollection is then assigned to the first mask image, while the matrix at the bottom is assigned to the second mask image.

Then all the message pixels and all the mask matrices are assembled to make up the first and second mask images.

For the message image M of 18720 pixels, it is necessary to have a random sequence which contains 18720 values, each value allowing randomly to select one-out-of-six subcollections. For a binary encoding, three bits are therefore needed for each drawing. In the case of our example, a sequence of 56160 bits, that is, 7020 bytes, is required. This random sequence will then be divided into three-bit groups used for each drawing or for the subcollection choice.

The invention proposes to use as a random sequence the material signature, for example, of at least a part of the product's structure, the material signature being extracted from at least one structural characteristic of at least one region R of the material object O. According to the illustrated example, the region R is located on the upper surface of the material object O. The material signature can be extracted by all suitable means such as described in the FR 2 895 543 request. According to the illustrated example in FIG. 7, a portable communication terminal SP equipped with an ad hoc accessory such as described by the FR 2 895 923 request is implemented. Thus, a material signature of 7 020 bytes is obtained, and the bytes are used as previously described.

The mask images can be used directly to reveal to a user the message image by overlaying the mask images. The invention proposes, however, to implement the support image to construct the shared images from the mask images. The use of the support image allows recognising or indexing the shared images, which is not possible with the mask images. Thus, the shared images have two levels of information: the first level is offered by the support image directly accessible for each shared image alone, while the second level of information constituted by the message image is only accessible by means of the union of the two shared images. In addition, the support image allows conferring a more aesthetic aspect to the shared images.

Each shared image is constructed by assigning to each pixel of the shared image the value obtained by multiplying the values of the corresponding pixels of the mask image and the support image. The corresponding pixel is understood to be a pixel having the same position in the mask or support image as the pixel in the shared image.

Once the shared images P₁ and P₂ are constructed, they can be recorded.

According to the first form of implementation, the invention proposes to record as shown in FIG. 8 the first shared image in a remotely accessible database DB, while the second shared image P₂ is recorded in printed form on the rear surface of the object O as shown in FIG. 9.

When a purchaser or a user U of the object O wants to verify the authenticity of the object O, he queries with a portable device SP—like a smart phone—the database DB by supplying it, for example, the code associated with the bar code C marked on the rear surface of the object O. The database responds by sending the first shared image P1. The user then takes a photo of the second shared image P2 and the portable device SP overlays the shared images P1 and P2 which—if both images are authentic—offer the image as shown in FIG. 10. The user knows he has an authentic product due to the fact that he can read the message M. In addition, he can proceed with an additional verification by using all or a part of the information of the message image to query a database.

The device used to extract the material signature during the construction of the shared images and/or the verification phase can contain any type of image acquisition system, such as a flatbed scanner, a USB linear scanner, a camera.

In a second implementation example, the invention proposes to take advantage of the fact that the incidental used to construct the shared images is a material signature which has the characteristic of being extractable on request by being at each extraction identical or quasi-identical to the material signature used for the generation of the shared images P1 and P2. This characteristic of the material signature is also called a replayable character. According to this second example, it is proposed to record as previously the second shared image P2 by printing it on the object O, while the first shared image P1 is reconstructed at the moment of the verification by the user. To do this, the message image M must be known or at least generatable at the moment of the construction of the second shared image.

To this end, it is possible to use a part of the material signature, which, incidentally, is also used to construct the shared images P1 and P2. For example, the part M1 of the message image intelligible for man can correspond to the first 22 bits of the material signature, while the part M2 interpretable by an artificial system can correspond to the first 576 bits of the material signature.

When the user has in his possession the object O on which the second shared image P2 is printed, he can use a communication terminal SP adapted to extract the material signature from the region R indicated on the upper surface 1 of the object O. The terminal SP is, in addition, adapted to generate with this material signature the message image M and the first shared image P1. The communication terminal is, in addition, adapted to take a photo of the second shared image P2 and overlay this image on the first shared image that it will have reconstructed.

If the user sees the image displayed as shown in FIG. 10, he will have the first confirmation of authenticity. The communication terminal SP can, in addition, be adapted to display the first 22 bits of the material signature which it will have extracted. The user can then compare the values of the part M1 of the message image and the values displayed to verify the match. Thus, a second level of authentication is offered. The part M2 of the message image can, in addition, be used by the communication terminal to perform an automated check of the match between the value of the material signature incorporated in the message image and the material signature extracted during the authenticity check by the user.

According to a third implementation variant, the invention proposes to use the replayable character of the material signature to allow a construction of the first shared image without any knowledge of the message. To this end, the collections C₀ and C₁ have the same number of subcollections or columns and a line of rank i of the first collection C₀ has the same matrices as the line of the same rank i of the second collection C₁. Thus, the mask image of rank i is independent of the message image and depends only on the material signature used. According to the example of collections shown in FIG. 5, line Mq₁ of the first collection C₀ is identical to line Mq₁ of the second collection. The first mask image will therefore be independent of the message image and will only depend on the incidental used during the construction of the mask images, that is, within the scope of the invention, the material signature.

An implementation scenario of this third variant consists of, for example, recording by printing the second shared image on the object and then during the verification of constructing the first shared image with the material signature extracted as previously explained. The used support image may then be an image of a part of the object or a predefined image stored in the device ensuring the reconstruction of the first mask image. It should be underlined that the possibility of recognising the support image from the second shared image allows the user to determine himself the support image to be implemented. In addition, the support image incorporated with the second shared image can supply the user with information about the location of the region of the object from which the material signature is extracted.

Another possible implementation scenario of this third variant can also be the following. The shared images P₁ and P₂ are constructed with the mask images applied to a support image S which contains an identifier code for an automatic reading system as shown in FIG. 11. The message image M shown in FIG. 12 includes an image of a part of a material structure of the object O. The second shared image P₂ shown in FIG. 13 is then recorded by printing on a label or an authenticity certificate associated with the object O. When a user or a holder of the object wants to check its authenticity, he proceeds using the portable device SP with the construction of the shared image P₁ shown in FIG. 13. This first shared image P₁ is then used in association with the second shared image P₂ to present to the holder the message image M and the support image S as shown in FIG. 14. The holder can then compare the message image M to the image of the material structure of the object in an area whose position may be indicated by the message image or marked on the object. This implementation scenario is particularly ideal for objects which must not be altered by the recording of a shared image on their surface.

In the previously described examples, the construction of the shared images to be shared P₁ and P₂ from the mask images Mq₁ or Mq₂ and the support image S is accomplished by multiplying the values of the corresponding pixels of the mask image Mq₁ or Mq₂ and the support image S. However, the construction of each shared image resulting from the application of a mask image to the support image can be accomplished by substituting by a predefined value the value of each pixel of the support image depending on the value of the corresponding pixel of the corresponding mask image. For example, if the value of the mask image pixel is 0, no substitution will take place, while if the value of the mask image pixel is 1, the value of the support image pixel will be substituted by the predefined value. This mode of operation can be advantageous for a coloured image. In fact, a first substitution value can be used for the first shared image and a second substitution value for the second shared image. The first substitution value can correspond to the first colour, while the second substitution value corresponds to a second colour. The first and second colours can then be selected so that during the overlaid presentation of the shared images P₁ and P₂ the message image M is displayed in a target colour resulting from the mix of the first and second colours. The target colour can then be selected to facilitate the reading of the message image.

Of course, diverse other scenarios for the implementation of the various presented variants of the invention, as well as other variants of the invention, can be envisioned within the scope of the attached claims.

1. Unitary authentication process of a material object (O) consisting of a construction phase of an authenticator system comprising at least:
a step to select a message image (M);
a step to select a support image (S);
a step to transform the message image (M) and the support image (S) in order to generate at least two shared images (P1, P2) according to a transformation process implementing at least one random sequence, the message image (M) not being accessible in each shared image (P1, P2) taken individually; and
a step to record at least one shared image (P2),
characterised by the fact that in the construction phase of an authenticator, each random sequence, the said material signature, is extracted or generated from at least one structural characteristic of at least one region (R) of the material object (O) and liable to be generated on request and identically from the material object (O).

2. Authentication process according to claim 1 wherein the construction phase of the authenticator system contains a step to decompose the support image (S) into a finite number of areas and by the fact that it includes at least for some areas, a step transforming the message image (M) and the support image (S) to generate at least two shared images (P1, P2) specific to each area according to a transformation process implementing at least one material signature generated from at least one structural characteristic of at least one region of the said area of the material object (O).

3. Authentication process according to claim 1, wherein the construction phase of the authenticator system contains a step to record the location of the region of the object from which the material signature is generated.

4. Authentication process according to claim 1, wherein the message image (M) contains at least one part of the material signature in an alphanumeric or graphic form.

5. Authentication process according to claim 1, wherein the support image (S) contains an image of a region of the material object and/or the structure of a region of the material object.

6. Authentication process according to claim 1, wherein the support image (S) contains graphic data of an indexing or identification type interpretable by the human visual system and/or by an artificial optical recognition or reading system.

7. Authentication process according to claim 1, wherein the message image (M) contains an image of a region of the material object (O) and/or the structure of a region of the material object.

8. Authentication process claim 1, wherein the support image (S) is selected among the following types of images:
coloured image;
grey-scale image;
binary image, such as an image with two visual components, like two separate colours, or else two components, one having a specular behaviour and the other a diffusing behaviour;
half-tone image; and
image resulting from the assembly of two or more images of the above types.

9. Authentication process according to claim 1, wherein the message image (M) is a binary image, such as an image with two visual components.

10. Authentication process according to claim 1, wherein the construction phase of the authenticator system contains a step to record at least one of the shared images (P1, P2) in numeric form.

11. Authentication process according to claim 1, further comprising a step to record at least one (P2) of the shared images (P1, P2) in printed form.

12. Authentication process according to claim 11, wherein the construction phase of an authenticator system contains a step to print at least one of the shared images on the material object (O).

13. Authentication process according to claim 1, wherein the construction phase of an authenticator system contains a step to record in printed form at least one shared image (P2) and a step to record at least another shared image (P1) in numeric form.

14. Authentication process according to claim 1, further comprising a verification phase by a user consisting of:
a presentation step of a shared image (P1) to be viewed by the user;
and at least another presentation step of another shared image (P2) to be viewed by the user;
the presentation steps being carried out so that the user perceives the shared images (P1, P2) as being overlaid to allow a reading of the message image (M) by the user.

15. Authentication process according to claim 14, wherein the presentation steps are carried out successively in order to implement a retinal persistence phenomenon in the user.

16. Authentication process according to claim 14 wherein the presentation steps are carried out simultaneously.

17. Authentication process according to claim 14, wherein at least one presentation step is carried out by means of an electronic display or projector.

18. Authentication process according to claim 14, wherein at least one presentation step is carried out by means of at least one printed shared image (P2).

19. Authentication process according to claim 14, wherein the verification phase includes a step to extract the material signature.

20. Authentication process according to claim 14, wherein the verification phase includes a step to generate or construct a shared image (P1).

21. Authentication process according claim 14, wherein the verification phase includes a step to download a shared image (P1) from a remote server (RS).

22. Authentication process according to claim 1, wherein at least one shared image (P1) is independent of the message image (M), and each other shared image (P2) depends on the message image (M).

23. Authentication process according to claim 1, wherein, in the step of transforming the message image (M) and the support image (S) into at least two shared images (P1, P2), each shared image presents the support image (S) in an altered form, and wherein, during an overlaying of the shared images (P1, P2), an image is obtained which contains the support image (S) in its original form and the message image (M).
